(19) United States
(12) Patent Application Publication
(10) Pub. No.: US 2006/0165159 A1
(43) Pub. Date: Jul. 27, 2006

(54) Method for transmitting digital electrical signals

(76) Inventor: Valery Vasilievich Ovchinnikov, Moscow (RU)

Correspondence Address: LADAS & PARRY, 26 WEST 61ST STREET, NEW YORK, NY, 10023, US

(21) Appl. No.: 10/528,332

(22) PCT Filed: Sep. 15, 2003
(86) PCT No.: PCT/RU03/00402

§ 371 Date: Mar. 18, 2005

(30) Foreign Application Priority Data
Sep. 23, 2002 (RU) 2002125391

(51) Int. Cl. H04L 5/16

(52) U.S. Cl. 375/219

(57) ABSTRACT

The invention relates to methods for transmitting information, in particular to communication interfaces of electronic devices. The inventive method makes it possible to extend a communication distance and liability improving noise immunity by compensating a noise signal in both wires of a communication line. Said method consists in grounding the first pole of a source and the first wire of the communication line, and in connecting the second wire of said line to the second pole of the source through a resistor during digital signals transmission from an transmitter to a receiver which are disposed on a two-wire communication line and provided with the power source. A logical signal is transmitted in a binary code by closing the line by the transmitter with the aid of an electric key and the voltage value of the signal in the second wire is read out with the aid of the receiver when the first wire of the communication line is grounded through an additional resister whose value is equal to that of the first resister.

### SCOPE

This invention relates to methods of transferring data, particularly to methods of transferring data to communications interfaces of electronic devices.

### PRIOR ART

A method is known for binary-code transferring of discrete electrical signals from a transmitter to a receiver, which are interconnected by a three-wire communication line where the power voltage source of the communication line is aligned with the transmitter, comprising single-wire, referred to a common wire (earth) transfer of a logic unit and a logic zero from the transmitter by applying a negative or positive voltage to its output and reading, by the receiver, of the voltage value in the wire referred to earth as well as transfer of the signal by the same technique via another wire in the reverse direction using another “transmitter-receiver” pair. The method is known as RS 232 interface (“IBM PC hardware,” Encyclopedia, Saint Petersburg, Publishing House “Peter,” 2001, p. 669 [in Russian]).

The disadvantages of the known method are its low noise immunity and short link length, which usually does not exceed 10 m. This is explained by different conditions of current flow in line wires: the resistance in the circuit of transferring wires is higher than the resistance in the circuit of the common wire (earth), which contributes to the development of noise voltage under the effect of electromagnetic fields.

Furthermore, the known method makes it possible to transfer data only to one receiver and requires an arrangement of an independent bipolar electric power supply, which makes that piece of hardware more expensive.

Also known is a method for binary-code transferring of discrete electrical signals from a transmitter to a receiver, which are located in a three-wire communication line where the power voltage source of the communication line is aligned with the transmitter, comprising transfer of the logic unit by simultaneously applying a negative voltage to one wire and a positive voltage to another wire referred to the third wire and transfer of the logic zero by applying a close-to-zero voltage to the first and second wires referred to the logic zero of the third wire and reading, by the receiver, of the voltage value in the first and second wires of the line. The method is known as RS 485 interface (“IBM PC hardware,” Encyclopedia, Saint Petersburg, Publishing House “Peter,” 2001, p. 669 [in Russian]).

That method features a higher noise immunity and a longer link (up to 1000 m) making it possible to interconnect many devices and therefore providing for signal transfer in both directions. However, like the previous method, it requires an arrangement of an independent bipolar electric power supply for all devices connected to the line, which makes that method significantly more expensive. Furthermore, separate power supply of the devices and the longer link between them result in mismatching of their zero bus (earth) potentials, which can cause device failures. In order to prevent such failures, galvanic separation of the devices from the line is used, which makes that data transfer method even more expensive.

The method for transferring electrical signals via the MicroLAN bus (“Automatic Identification Data-Book,” Dallas Semiconductor, 1995; www.Dalsemi.com) is the closest prototype of the claimed method in terms of its technical essence and achievable result. That known method for transferring of discrete electrical signals from a transmitter to a receiver, which are located in a two-wire communication line with a power voltage supply, where the first pole of the power supply and the first wire of the communication line are grounded while the second wire of the communication line is connected to the second pole of the power supply via a resistor, comprises binary-code transfer of a logic signal through closing of the line by the receiver using an electric key and reading, by the receiver, of the value of voltage in the wire referred to earth. In doing so, the logic zero is usually the signal level of less than 50% of the nominal line voltage while the logic unit is the signal level of more than 50% of the nominal line voltage. Many other known interfaces are arranged similarly to the MicroLAN interface.

That method makes it possible to interconnect many devices and provides for signal transfer in both directions via two wires and supports network power supply, which makes the method less expensive.

The disadvantage of that method is its low noise immunity.

### DISCLOSURE OF INVENTION

This invention addresses the problem of increasing noise immunity in transferring electric signals in a line with simultaneous reduction of the costs of the data transfer process.

That problem is solved as follows: in the method for transferring of discrete electrical signals from a transmitter to a receiver, which are located in a two-wire communication line with a power voltage supply where the first pole of the power supply and the first wire of the communication line are grounded while the second wire of the communication line is connected to the second pole of the power supply via a resistor, comprising binary-code transfer of a logic signal through closing of the line by the receiver using an electric key and reading, by the receiver, of the value of voltage in the second wire, the first wire of the communication line is grounded via an additional resistor whose value is equal to the value of the first resistor and signal transfer and the signal's voltage value reading are referred to the first wire of the communication line.

The essence of this invention is as follows:

When noise affects both line wires, the result of its effect in each of them can be different since the conditions of noise propagation in grounded and ungrounded line wires are different.

In this method of transferring electrical signals, those conditions are the same in both line wires and therefore compensation of the noise signal takes place. In doing so, the noise signal level is reduced by a factor of thousands, which makes it possible to complete communication under conditions where, with the use of the prototype method, the noise voltage would considerably exceed the useful signal.

### EXAMPLE

The first pole of the power supply is connected to the grounding point while the second wire of the two-wire communication line is connected to the second pole of the power supply via a resistor. The first wire of the communication line is connected to the grounding point via an additional resistor whose value is equal to the value of the first resistor. The receiver and the transmitter are connected to arbitrarily chosen points of the communication line wires; in doing so, the receiver measures the signal voltage in the first wire referred to the second wire (floating earth). The regular status of the line corresponds to the transfer of the logic unit while the logic zero is formed through closing of the line by the transmitter.

The line wires are placed in an electromagnetic field that creates the noise or the noise voltage from a generator is applied to both line wires. The noise voltage is measured between the line wires close to the receiver. Due to compensation, the noise voltage is thousands of times lower than the noise voltage referred to earth.

### INDUSTRIAL APPLICABILITY

The advantage of this invention is provided as follows: because identical signal propagation conditions are provided in both line wires, the in-line noise voltage is compensated. This makes it possible to increase the range and reliability of communications by increasing noise immunity.

1. A method for transferring of discrete electrical signals from a transmitter to a receiver, which are located in a two-wire communication line with a power voltage supply where the first pole of the power supply and the first wire of the communication line are grounded while the second wire of the communication line is connected to the second pole of the power supply via a resistor, comprising binary-code transfer of a logic signal through closing of the line by the receiver using an electric key and reading, by the receiver, of the value of voltage in the second wire, whereby the first wire of the communication line is grounded via an additional resistor whose value is equal to the value of the first resistor and both signal transfer and the signal's voltage value reading are referred to the first wire of the communication line.
